(19) United States
(12) Patent Application Publication
(10) Pub. No.: US 2011/0030556 A1
(43) Pub. Date: Feb. 10, 2011

(54) METHOD AND SYSTEM FOR GENERATING OXYGEN-ENRICHED GAS

(75) Inventors: DANA G. PELLETIER, ORTONVILLE, MI (US); MICHAEL S. McCLAIN, ORTONVILLE, MI (US)

Correspondence Address: Delphi Technologies, Inc., M/C 480-410-202, P.O. Box 5052, Troy, MI, 48007, US

(73) Assignee: DELPHI TECHNOLOGIES, INC., TROY, MI (US)

(21) Appl. No.: 12/536,553

(22) Filed: Aug. 6, 2009

(51) Int. Cl. B01D 53/04; B01D 53/047; B01D 53/053

(52) U.S. Cl. 95/102; 96/121; 96/113; 95/90; 96/130; 95/96

(57) ABSTRACT

An oxygen generating system includes an oxygen generating unit including a housing having disposed therein i) at least two sieve beds, ii) a piston disposed between and operatively connected to the sieve beds, and iii) at least one magnet operatively disposed on the piston. A coil is wrapped around an exterior surface of the housing and is in operative communication with the magnet(s). The coil is configured to drive the piston along a length of the housing between the sieve beds during at least one stage of an oxygen generating cycle. The driving of the piston is accomplished via an electromagnetic field formed between the coil and the magnet(s). Also disclosed herein is a method for generating an oxygen-enriched gas using the oxygen generating system.

### BACKGROUND

The present disclosure relates generally to oxygen generation and, more particularly, to a method and system for generating oxygen-enriched gas.

Oxygen generating systems are often used to produce an oxygen-enriched gas for a user. Many oxygen generating systems include a gas fractionalization system configured to separate oxygen from other components (e.g., nitrogen) in a feed gas to produce the oxygen-enriched gas. The feed gas is often compressed prior to the separation using a compressor assembly. The gas fractionalization system, for example, may include one or more sieve beds having a nitrogen-adsorption material disposed therein and configured to adsorb at least nitrogen from the feed gas. Adsorption may be accomplished via a pressure swing adsorption (PSA) cycle, a vacuum/pressure swing adsorption (VPSA) cycle, or the like. The oxygen-enriched gas is ultimately delivered to the user.

### SUMMARY

An oxygen generating system is disclosed herein. The oxygen generating system includes an oxygen generating unit including a housing having disposed therein i) at least two sieve beds, ii) a piston disposed between, and operatively connected to the at least two sieve beds, and iii) at least one magnet operatively disposed on the piston. The oxygen generating system further includes a coil wrapped around an exterior surface of the housing and in operative communication with the at least one magnet. The coil is configured to drive the piston, via an electromagnetic field formed between the coil and the at least one magnet, along a length of the housing between the sieve beds during at least one stage of an oxygen generating cycle. Also disclosed herein is a method for generating an oxygen-enriched gas.

### BRIEF DESCRIPTION OF THE DRAWINGS

Features and advantages of embodiment(s) of the present disclosure will become apparent by reference to the following detailed description and drawings, in which like reference numerals correspond to the same or similar, though perhaps not identical components. For the sake of brevity, reference numerals having a previously described function may or may not be described in connection with subsequent drawings in which they appear.

FIG. 1 is a schematic diagram of an example of an oxygen generating system including an oxygen generating unit;

FIGS. 2A and 2B are cross-sectional, schematic views of embodiments of the oxygen generating unit of FIG. 1;

FIG. 3 is a diagram depicting patterns of driving the piston during an oxygen generating cycle; and

FIG. 4 is a diagram depicting an example of a timing sequence for a fill valve, a vent valve, and a piston of the oxygen generating system of FIG. 1, as well as the pressure of the oxygen generating unit during stages of an oxygen generating cycle.

### DETAILED DESCRIPTION

Embodiment(s) of the system and method, as disclosed herein, advantageously use an oxygen generating unit incorporating, into a single unit, i) the structure, and/or ii) the function of at least three primary sub-assemblies of an oxygen generating system. Such sub-assemblies include, for example, i) a sieve bed assembly, ii) a compressor assembly, and iii) a valve assembly. By incorporating the structure and/or the function of the foregoing sub-assemblies into the single oxygen generating unit, the oxygen generating system may advantageously i) include a smaller amount of material and/or equipment (with respect to, e.g., tubing, valves, pumps, and/or the like), ii) have a simplified design scheme, iii) be smaller in size and/or in weight, and/or iv) operate more efficiently/economically. The oxygen generating system using the oxygen generating unit is also adaptable to indoor and outdoor environmental conditions, making the oxygen generating system usable in portable applications.

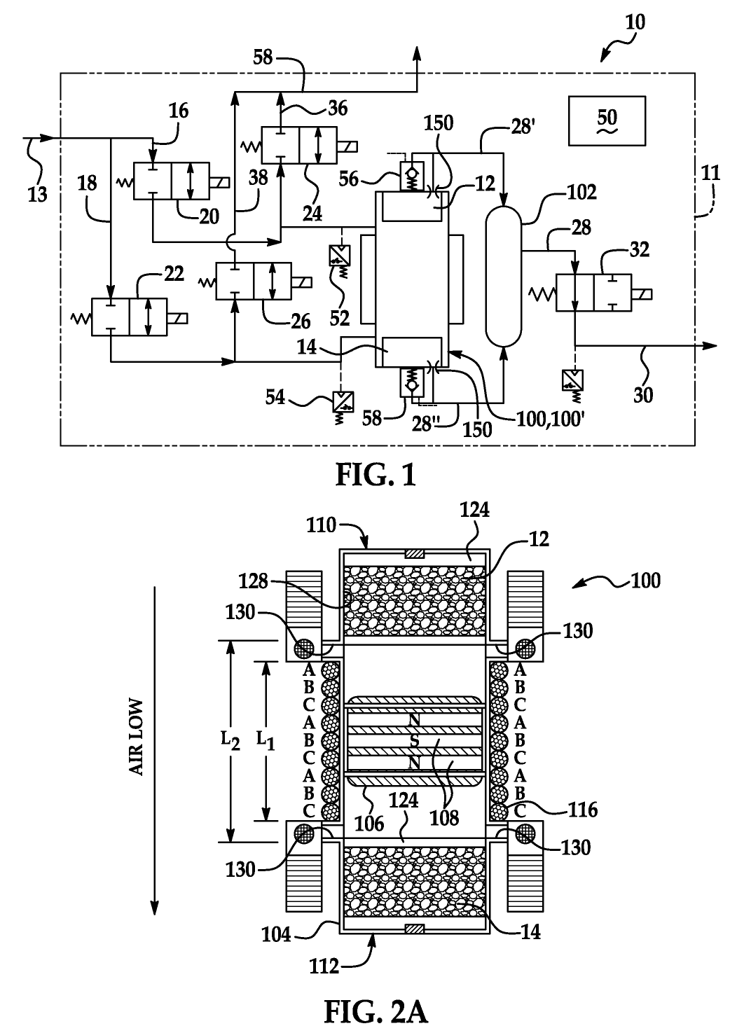

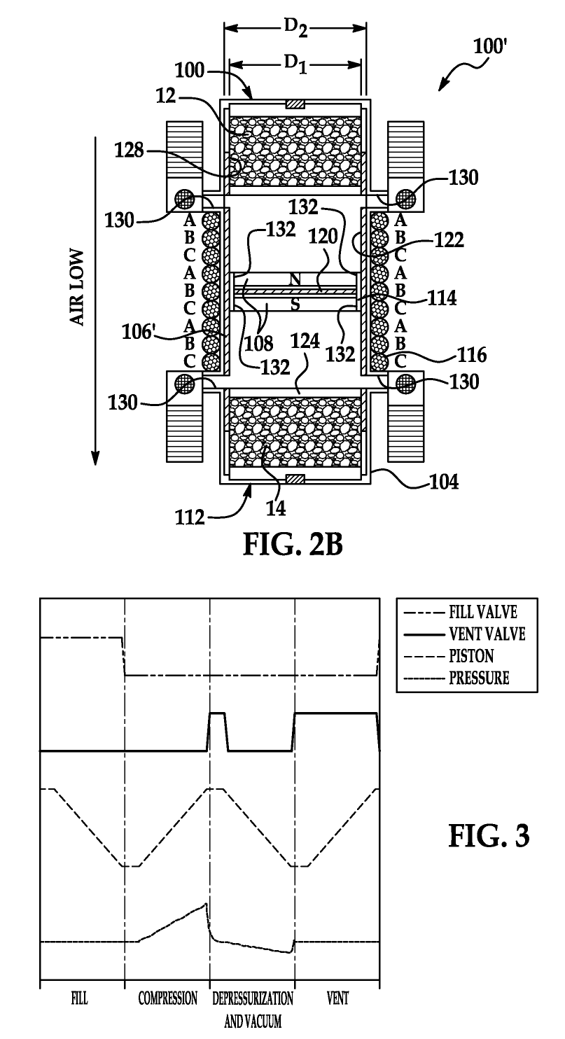

Embodiments of the oxygen generating system 10 are described herein in conjunction with FIG. 1, while embodiments of the oxygen generating unit 100, 100′ are described herein in conjunction with FIGS. 2A and 2B, respectively. The description of the oxygen generating system 10 that follows includes some embodiments and/or examples thereof. It is to be understood, however, that other embodiments and/or examples of the system 10 may also be contemplated herein, although not necessarily described in detail in conjunction with the figures. For example, any oxygen generating system supporting any embodiments of the oxygen generating unit 100 may suitably be used.

It is further to be understood that the embodiments of the oxygen generating system 10 use a nitrogen adsorption process to generate oxygen-enriched gas for a user thereof. For example, the nitrogen adsorption process may be a pressure swing adsorption (PSA) process or a vacuum pressure swing adsorption (VPSA) process, where such processes operate in repeating adsorption/desorption cycles. As will be described in detail below in conjunction with FIG. 4, each cycle includes at least a fill stage, a compression stage, a depressurization stage, a vacuum stage, and a vent stage.

An example of the oxygen generating system 10 is schematically depicted in FIG. 1. The oxygen generating system 10 is generally configured to generate an oxygen-enriched gas from a feed gas. The generation of the oxygen-enriched gas may be accomplished i) according to a pre-set time interval, ii) on demand from a user of the system 10, or iii) combinations thereof.

Referring now to FIG. 1, the feed gas is drawn into the system 10 through an inlet 13 defined in a housing or chassis 11. In a non-limiting example, the feed gas is air taken from the ambient atmosphere, which includes at least nitrogen, oxygen, and water vapor.

The oxygen generating system 10 generally includes the oxygen generating unit 100, 100′ and a number of valves (e.g., fill valves, user delivery valves, check valves, vent valves, etc.) operatively associated therewith. The fill valves, vent valves, and check valves may be any suitable combination of 2-way valves, 3-way valves, 4-way valves, etc. Such valves will also be described in further detail hereinbelow, as well as other equipment that may be incorporated into the system 10.

The oxygen generating unit 100, 100′ is configured to selectively receive the feed gas during a predetermined supply period. In an example, when the feed gas is drawn into the system 10 via the inlet 13, the air is introduced into first 12 and second 14 sieve beds disposed inside the unit 100, 100′ via first 16 and second 18 supply conduits, respectively.

The first 16 and second 18 supply conduits are generally operatively connected to first 20 and second 22 fill valves, respectively. In a non-limiting example, the first 20 and second 22 fill valves are two-way valves. As provided above, the nitrogen adsorption process employed by the oxygen generating system 10 operates via cycles, where one of the first 12 or second 14 sieve beds vents to atmosphere nitrogen-enriched (waste) gas, while the other of the first 12 or second 14 sieve beds delivers oxygen-enriched gas either i) directly to the user, or ii) to a product tank 102 where the gas is at least temporarily stored therein. During the next cycle, the functions of the respective sieve beds 12, 14 switch. Switching is accomplished by opening the respective feed gas fill valve 20, 22 while the other of the feed gas fill valves 20, 22 is closed. More specifically, when one of the first 12 or second 14 sieve beds is receiving the feed gas, the respective one the first 12 or second 22 fill valves is activated (or in an open position). In this case, the feed gas is prevented from flowing to the other of the first 12 or second 14 sieve beds. In an embodiment, the opening and/or closing of the first 20 or second 22 fill valves may be controlled with respect to timing of the opening and/or closing and/or with respect to the sequence in which the first 20 and second 22 fill valves are opened and/or closed.

After receiving the feed gas, the first 12 and second 14 sieve beds are each configured to separate at least most of the oxygen from the feed gas to produce the oxygen-enriched gas. The separation may be accomplished using a nitrogen adsorption process (as described above). In an embodiment, the first 12 and second 14 sieve beds include a nitrogen-adsorption material (e.g., zeolite, other suitable materials) configured to adsorb at least nitrogen from the feed gas. Generally, the feed gas is introduced into one of the first 12 or the second 14 sieve beds and nitrogen and possibly other components present in the feed gas are adsorbed by the nitrogen-adsorption material during an appropriate PSA/VPSA cycle. In a non-limiting example, the nitrogen-adsorption material may be selected from particles of Li—X type zeolite, having a particle size ranging from about 400 to about 600 microns in diameter (assuming the particles are spherical). In an example, the oxygen-enriched gas generated via the nitrogen adsorption process generally has an oxygen content ranging from about 70 vol % to about 95 vol % of the total gas product. In another example, the oxygen-enriched gas has an oxygen content of at least 87 vol % of the total gas product.

As shown in FIGS. 2A and 2B, the nitrogen-adsorption material of each sieve bed 12, 14 is packed between a pair of diffusers 124, which retain and compress the nitrogen-adsorption material to i) maximize packing pressure, and ii) prevent gaps through which gases may bypass the material. In other words, the diffusers 124 allow substantially uniform (i.e., plug) flow of gas through the nitrogen-adsorption material and prevent nitrogen leaks therethrough, whereby such nitrogen may end up in the oxygen-enriched product.

Embodiments of the oxygen generating unit 100, 100′ are schematically depicted in FIGS. 2A and 2B, respectively. In these embodiments, the oxygen generating unit 100, 100′ generally includes a housing 104 having incorporated therein i) at least one sieve bed (two of which are shown in FIGS. 2A and 2B, and identified by the first sieve bed 12 and the second sieve bed 14), ii) a piston (identified by reference numeral 106 in FIG. 2A and reference numeral 106′ in FIG. 2B) disposed between, and operatively connected to the first 12 and second 14 sieve beds, and iii) at least one magnet 108 operatively disposed on the piston 106.

The housing 104 of the oxygen generating unit 100 may be any shape that is easily formed and/or suitable for use as, e.g., a pressure vessel. In an example, the housing 104 is generally cylindrically-shaped, and is made from an aluminum material, a magnesium material, a plastic material, or combinations thereof. The aluminum or magnesium may, for example, exhibit desirable thermal transfer properties with desirable material strength, as compared to other materials, even though many other materials may work. It is to be understood, however, that the housing 104 is not made from ferrous materials because such materials may block magnetic fields needed to drive the piston 106 (which will be described in further detail below). The housing 104 may also be formed of shapes other than a cylinder, examples of which include a square shape, a rectangular shape, a triangular shape, a trapezoidal shape, and/or the like.

The first 12 and second 14 sieve beds are disposed inside the housing 104 at opposing ends 110, 112 thereof. As shown in FIGS. 2A and 2B, the first sieve bed 12 is disposed inside the housing 104 adjacent to the end 110, and the second sieve bed 14 is disposed inside the housing 104 adjacent to the opposed end 112. In the embodiment of the oxygen generating unit 100 depicted in FIG. 2A, the sieve beds 12, 14 are generally shaped in conformance with the shape of an interior 128 surface of the housing 104. In this embodiment, the diameter of the sieve beds 12, 14 is about the same diameter of the interior surface 128, or a fraction smaller, so that the sieve beds 12, 14 abut the interior surface 128.

Still referring to the embodiment shown in FIG. 2A, the piston 106 is disposed inside the housing 104 between the first 12 and the second 14 sieve beds. In this embodiment, the piston 106 is a rod, a cup, a puck, or another object (generally having a circumference) that is configured to move in response to a force. In a non-limiting example, the piston 106 is formed from any suitably durable material, examples of which include aluminum, magnesium, or combinations thereof. In an embodiment, at least one seal 114 (e.g., an o-ring seal) may be disposed on the piston 106 to provide a substantially air-tight, oil-less seal between the piston 106 and the housing 104. The seal may substantially prevent fluid communication between i) the first sieve bed 12 and the housing 104 and/or ii) the second sieve bed 14 and the housing 104.

In the embodiment of the oxygen generating unit 100 shown in FIG. 2A, the magnet(s) 108 is/are operatively disposed on the piston 106 and around the circumference of the piston 106. The magnet(s) 108 may be shaped as a ring or as a disc (as shown in FIG. 2A). The magnet(s) 108 is/are in operative communication with at least one coil 116 wrapped around an exterior surface 118 of the housing 104. In an example, the coil 116 is a single coil wrapped around the exterior surface 118 and along a length L of the housing 104. In another example, the coil 116 is an array of coils (identified by reference numerals A, B, and C in FIG. 2A) wrapped around the exterior surface 118 and along the length L₁ of the housing. In an embodiment, the coil 116 is a copper stator coil.

The coil 116 is generally configured to drive the piston 106 along the length L₂ of the housing 104 between the first 12 and second 14 sieve beds during at least one stage of an oxygen generating cycle. The driving of the piston 106 is analogous to a linear motor, which may be used to drive the oxygen generating system 10 through the several stages of each oxygen generating cycle to generate the oxygen-enriched gas. FIG. 4 provides a schematic diagram showing the motion of the linear motor using three phase stator coils wrapped in alternating bands around the housing 104. In some instances, ferrous channels may also be used between each coil to increase coupling to the piston 106. The piston 106 also includes three rings of permanent magnets 108 embedded in its walls, where each consecutive ring presents an opposite magnetic pole. The piston 106 (and the piston 106′ as described below in conjunction with FIG. 2B) may be moved by energizing the coil 116 in a prescribed pattern, thereby producing an appropriate driving force to move the piston 106 either toward or away from, e.g., sieve bed 12 or sieve bed 14. Such patterns of driving the piston 106 are shown in FIG. 4 and described in further detail below.

In the other embodiment of the oxygen generating unit 100′ shown in FIG. 2B, the piston 106′ is a moveable sleeve that is also generally cylindrically-shaped and is configured to move in response to a force. It is to be understood that the moveable sleeve may, however, have any geometric shape so long as the shape does not interfere with the movability of the sleeve inside the oxygen generating unit 100′. In a non-limiting example, the piston 106′ is also formed from any suitably durable material, examples of which include aluminum, magnesium, or combinations thereof. The piston 106′ also includes a plate 120 (referred to herein as “a divider”) configured to divide the piston 106′ into two, air-tight halves. The divider 120 may be positioned proximate to the half-way point (i.e., the middle) of the piston 106′. The length of the piston 106′ is generally the length of the housing 104 minus the stroke displacement of the piston 106′.

In this embodiment, the magnet(s) 108 is/are disposed on an interior surface 122 of the piston 106′ sleeve. In an example, the magnet(s) 108 is/are contained inside the piston 106′ sleeve adjacent to the divider 120 (as shown in FIG. 2B). In an embodiment, at least one ring 114 may be disposed in the piston 106′ and is/are configured to retain the magnet(s) 108 inside the piston 106′. The ring(s) 114 are also configured to substantially prevent fluid communication between the sieve beds 12, 14.

Furthermore, in the embodiment depicted in FIG. 2B, the sieve beds 12, 14 are generally shaped in conformance with the shape of the interior surface 122 of the piston 106′. In this embodiment, the diameter D₁ of the sieve beds 12, 14 is slightly smaller than the diameter D₂ of the interior surface 122, allowing the piston 106′ sleeve to slide between the sieve beds 12, 14 and the interior surface 128 of the housing 104.

Embodiments of the oxygen generating unit 100, 100′ further include at least one port 130 configured to allow fluid communication into and out of the unit 100, 100′. The ports 130 (four of which are shown in FIGS. 2A and 2B) are formed into the housing 104. In the embodiment shown in FIG. 2B, additional ports 132 (four of which are also shown) are also formed into the piston 106′ sleeve and are in fluid communication with the ports 130 formed into the housing 104.

The oxygen generating unit 100, 100′ operates by moving the piston 106, 106′ in a linear motion, similar to a linear motor. To reiterate from above, upon energizing the coil 116, movement of the piston 106, 106′ may be accomplished in prescribed patterns in order to produce a suitable driving force toward and away the sieve beds 12 or the sieve bed 14. Such patterns are schematically shown in FIG. 4 and are identified therein as Patterns 1-12. The energizing of the coil 116 may be accomplished, for example, using suitable electronics operated by control software. In an example, the processor 50 may be used to energize the coil 116.

Referring now to the patterns shown in FIG. 4, it is to be understood that the magnets 108 are configured relative to the array of coils 116 (identified by reference characters A, B, and C in FIG. 4) in a 3-to-2 ratio. In this configuration, two of the three coils 116 are energized in alternate directions (e.g., perpendicularly into or out of the page) for each stage of the oxygen generating cycle (which will be described in detail hereinbelow). The patterns are generally designed, at least in part, to attract one of the magnets 108 toward a given coil (e.g., the coil A) and to repel another magnet from that same coil (coil A) so that the magnets 108 move in a desired direction. The arrows depicted in each pattern shown in FIG. 4 indicate the force(s) applied to the magnets 108. In a non-limiting example, when the magnets have moved with the piston 106, 106′ to their possible furthest distance (as shown, e.g., in patterns 2, 4, 6, 8, 10, and 12 in FIG. 4) for a given energy coil pattern, the coil energization pattern changes (as shown, e.g., in patterns 1, 3, 5, 7, 9, and 11) to keep the piston 106, 106′ moving.

It is to be understood that the coil 116 is also configured to provide voltage and current feedback to a processor 50 (shown in FIG. 1), where such information indicates the then-current motion of the piston 106, 106′. As the piston 106, 106′ displacement reaches a maximum for a given pattern, the processor 50 advances to the next pattern, and the piston 106, 106′ continues to move. In a non-limiting example, the voltage and current information may be obtained by and fed back to the processor 50 using one or more pressure sensors 52, 54 (also shown in FIG. 1) operatively connected to the sieve beds 12, 14. The output of the pressure sensors 52, 54 are voltages that are proportional to pressure and produce a pressure waveform. Such outputs may then be fed into an analog-to-digital converter (not shown) in the processor 50. From the pressure waveforms, the processor 50 may deduce what the then-current position of the piston 106, 106′ is. Further, data related to the velocity that the piston 106, 106′ is moving may be deduced from a timer (now shown) operatively disposed on the coil 116. In a non-limiting example, the pressure sensors 52, 54 are also configured to detect leaks and/or the performance of potentially degraded nitrogen adsorption material in the sieve beds 12, 14.

In an example, the processor 50 is further configured to control the movement of the piston 106, 106′ in a manner so that the piston 106, 106′ does not crash into the sieve bed diffusers 124. In such instances, the impact would generate mechanical shocks that would travel through the diffusers 124 and into the nitrogen adsorption material. Such mechanical shocks may potentially break down the nitrogen adsorption material, block gas flow through the material, and/or generate undesirable dust particles in the oxygen generating unit 100, 100′. The dust particles may, for example, wear down some of the equipment operatively associated with the unit 100, 100′ such as, but not limited to, the piston rings 114, one or more valves associated with the unit 100, 100′, and/or the like. In a non-limiting example, the movement of the piston 106, 106′ may be controlled by providing an optical proximity sensor, an optical beam interrupt sensor, a contact switch, or other similar device that would provide data showing uncertainty of the piston 106, 106′ location. In these instances, the processor 50 is further configured to drive the piston 106, 106′ back to a predetermined home position. In another non-limiting example, the piston 106, 106′ may be have associated therewith an optical encoder, which would provide complete position information of the piston 106, 106′ at all times that the piston 106, 106′ is moving. In yet another embodiment, the position of the piston 106, 106′ may be deduced using a Hall effect sensor to detect the position of the magnet(s) 108 during movement of the piston 106, 106′.

Since the piston 106, 106′ oscillates between the first 12 and second 14 sieve beds during each oxygen generating cycle, such oscillations may translate into vibration of the entire system 10. In an example, such vibration may be reduced by shock mounting the oxygen generating unit 100, 100′ to the housing or chassis 11 of the oxygen generating system 10.

Referring back to FIG. 1, the oxygen generating system 10 further includes a user conduit 28 having a user outlet 30 in alternate selective fluid communication with the first and second sieve beds 12, 14. The user conduit 28 may be formed from any suitable material, e.g., at least partially from flexible plastic tubing. In an embodiment, the user conduit 28 is configured substantially in a “Y” shape. As such, the user conduit 28 may have a first conduit portion 28′ and a second conduit portion 28″, which are in communication with the first and second sieve beds 12, 14, respectively, and merge together before reaching the user outlet 30. The user outlet 30 may be an opening in the user conduit 28 configured to output the oxygen-enriched gas for the user's use. The user outlet 30 may additionally be configured with a nasal cannula, a respiratory mask, or any other suitable device, as desired.

In another embodiment, the system 10 does not include a user conduit 28, but is configured with appropriate means to direct the oxygen-enriched gas to the user directly from the product tank 102. Such means may be involve one or more valves operatively associated with the product tank 102. In an example, the system 10 may be configured with a standard two-way valve to deliver a pulse or bolus of the oxygen-enriched product from the product tank 102 to the user. In another example, the system 10 may be configured with a proportional valve or, in some instances, a pressure regulator for regulating a substantially continuous stream or flow of the oxygen-enriched product from the product tank 102 to the user. In yet another example, the system 10 may be configured for both a pulsed flow and a continuous flow of the oxygen-enriched product to the user by including, for example, a combination of a two-way valve and a proportional valve.

The first conduit portion 28′ and the second conduit portion 28″ may be operatively connected to a product tank 102. In an embodiment, the product tank 102 is a reservoir configured to store the output of the oxygen-enriched gas from the oxygen generating unit 100, 100′. In an example, the first conduit portion 28′ and the second conduit portion 28″ may also be configured with check valves 56, 58 that separate a product end of the sieve beds 12, 14 from the product tank 102. In an example, the check valve 56 is operatively connected to the sieve bed 12 and the check valve 58 is operatively connected to the sieve bed 14. Both of the check valves 56, 58 are also operatively connected to the product tank 102. The check valves 56, 58 are configured to open or activate when the pressure of their respective sieve beds 12, 14 exceeds that in the product tank 102, thereby venting some of the non-adsorbed oxygen product into the product tank 102. When the pressure of the sieve beds 12, 14 falls below that of the product tank 102, the check valves 56, 58 close.

The user conduit 28 is operatively connected to the product tank 102 and may, in an example, be configured with a user delivery valve 32. In an embodiment, the user delivery valve 32 is configured as a two-way valve 60. It is contemplated that when the oxygen-enriched gas is delivered from the oxygen generating unit 100, 100′, into the product tank 102, and ultimately to the user conduit 28, the user delivery valve 32 opens, allowing the oxygen-enriched gas to be delivered to the user via the outlet 30. In another example, the user delivery valve 32 may be an orifice (e.g., to enable continuous flow), a proportional valve, a needle valve, or the like.

The oxygen generating system 10 further includes a vent conduit 58 configured to vent at least nitrogen and possibly other adsorbed and then desorbed components of the feed gas (referred to herein as nitrogen-enriched gas) from the first 12 and second 14 sieve beds during the oxygen generating cycle. As shown in FIG. 1, the nitrogen gas in the first sieve bed 12 is vented through a vent port/conduit 36 for the first sieve bed 12 when a first vent valve 24 is open, and the nitrogen-enriched gas in the second sieve bed 14 is vented through a vent conduit 38 for the second sieve bed 14 when a second vent valve 26 is open. The vent conduits 36 and 38 merge into the main vent conduit 58. It is to be understood that venting occurs after each oxygen generating phase. The gas not adsorbed by the nitrogen-adsorption material (i.e., the oxygen-enriched gas) is delivered to the product tank 102 or, in some instances, directly to the user through the user outlet 30.

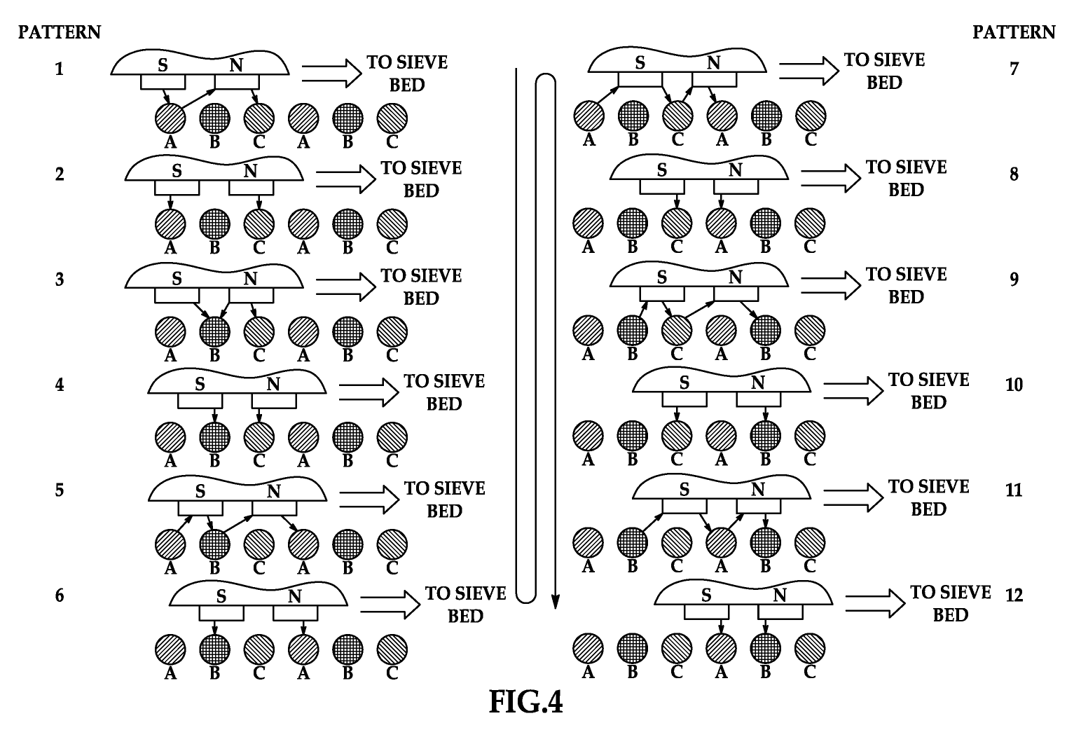

An example of a method of generating oxygen-enriched gas for a user will now be described herein in conjunction with FIG. 3. Using the examples of the oxygen generating system 10 described herein above in conjunction with FIGS. 1, 2A, 2B, and 4, the method includes generating the oxygen-enriched gas from the feed gas introduced into the system 10 via an oxygen generating cycle. The oxygen generating cycle generally includes multiple oxygen generating stages, where each stage corresponds to a stroke of the piston 106, 106′. In an example, the oxygen generating cycle includes a fill stage, a compression stage, a depressurization stage, a vacuum stage, and a vent stage. It is to be understood that the oxygen generating unit 100, 100′ employs a four-stroke approach to completing a single oxygen adsorption cycle, whereby the first 12 and the second 14 sieve beds are out-of-phase with each other since they share a common piston 106, 106′. For purposes of illustration, the oxygen generating method will be described hereinbelow starting with introducing the feed gas into the sieve bed 12. Furthermore, each “stroke” is referred to herein as the movement or travel of the piston 106, 106′ from one end (e.g., the end 110 of the unit 100, 100′ shown in FIGS. 2A and 2B) to the other end (e.g., the end 112 of the unit 100, 100′ shown in FIGS. 2A and 2B).

During the fill stage, the piston 106, 106′ is located at the end 110 of the unit 100, 100′ nearest to the sieve bed 12. Upon command from the processor 50, the fill valve 20 of the first sieve bed 12 is opened and, at substantially the same time, the first vent valve 24 is closed. Electric energy is supplied to the coil 116 to drive the piston 106, 106′ to a first position in the oxygen generating unit 100, 100′. In the instant example, the piston 106, 106′ is driven to a position adjacent to the second sieve bed 14, during which the feed gas is drawn into the oxygen generating unit 100, 100′ through the first fill valve 20. When the piston 106, 106′ reaches the position adjacent to the second sieve bed 14 (i.e., the piston 106, 106′ has stopped moving), the fill valve 20 closes.

Also during the fill stage, any oxygen-enriched gas stored in the product tank 102 may, in some instances, leak into the sieve bed 12 as a result, at least in part, of a differential back pressure between the product tank 102 and the ambient pressure in the chassis 11. In such instances, the orifice 150 partially opens and flushes any nitrogen desorbed from the nitrogen adsorption material into the oxygen generating unit 100, 100′. The flushing of the nitrogen substantially prevents the nitrogen from flowing out of the oxygen generating unit 100, 100′ and into the product tank 102.

After the fill stage is substantially complete, the compression stage begins. The processor 50 sends a command to close the fill valve 20 and the vent valve 24 of the first sieve bed 12. Also upon command from the processor 50, the piston 106, 106′ moves from the position adjacent to the second sieve bed 14 to a position adjacent to the first sieve bed 12. Upon such movement of the piston 106, 106′, the sieve bed 12 is pressurized and the feed gas present in the sieve bed 12 flows into the nitrogen adsorption material and compresses. The nitrogen adsorption material then adsorbs the nitrogen, leaving at least oxygen as a product. In some instances, the product also includes traces of argon and/or other non-adsorbed elements of the feed gas. The oxygen product thereafter flows to a product end of the oxygen generating unit 100, 100′. In instances where the pressure of the sieve bed 12 exceeds a predetermined value, the check valve 56 opens and the oxygen product (referred to herein as the oxygen-enriched gas) is allowed to flow out of the oxygen generating unit 100, 100′ and into the product tank 102.

After the generation of the oxygen-enriched gas, the oxygen generating system 10 goes through a depressurization stage. The fill valve 20 operatively associated with the sieve bed 12 is closed, while the vent valve operatively associated with the sieve bed 12 is opened. The opening of the vent valve 24 may be accomplished for a predetermined time period or until a desired pressure of the sieve bed 12 has been reached. The opening of the vent valve 24 depressurizes the sieve bed 12 and nitrogen is desorbed from the sieve bed 12. At least some of the desorbed nitrogen leaves the system 10 through the vent valve 24.

During the vacuum stage, the fill valve 20 and the vent valve 24 are closed in response to a command from the processor 50. The piston 106, 106′ moves to the other end 112 of the oxygen generating unit 100, 100′, adjacent to the sieve bed 14. During such movement, the piston 106, 106′ then draws a vacuum into the sieve bed 12, which desorbs a portion of the nitrogen from the nitrogen-adsorption material. Also during the vacuum stage, the orifice 150 allows some of the oxygen gas in the product tank 102 to flow back into the sieve bed 12 to flush the nitrogen-adsorption material of any remaining desorbed nitrogen-enriched gas. It is to be understood that such flow is substantially limited so that hardly any of the oxygen product exits the oxygen generating unit 100, 100′ beyond the diffuser 124.

During the vent stage of the oxygen generating cycle, the vent valve opens and the piston 106, 106′ moves back to the other end 110 of the unit 100, 100′ adjacent to the sieve bed 14. The movement of the piston 106, 106′ drives the desorbed nitrogen out of the sieve bed 12 and ultimately out of the system 10 through the vent conduit 36.

After the oxygen-enriched gas has been delivered to the product tank 102, a portion of the oxygen-enriched gas remains in the sieve bed 12. This oxygen gas is generally used to flush nitrogen-enriched gas out of the nitrogen-adsorption material during the depressurization and vacuum stages of the oxygen generating cycle. Additionally, some of the oxygen-enriched gas may also return to the sieve bed 12 from the product tank 102, via an orifice 150 (shown in FIG. 1), to assist in the flushing of the nitrogen from the sieve bed 12.

The oxygen generating cycle described hereinabove may then enter an alternate oxygen generating phase, where oxygen-enriched gas is generated using the second sieve bed 14. During this alternate phase of the oxygen generating cycle, the movement of the piston 106, 106′ during each stage of the oxygen generating cycle reverses, and appropriate valves operatively associated with second sieve bed 14 are opened/closed on command from the processor 50. After the generation of the oxygen-enriched gas via the second sieve bed 14, the oxygen generating cycle alternates back to the sieve bed 12. Such alternating phases of the oxygen generating cycle generally continue until a supply of oxygen-enriched gas is no longer needed. Upon which time, the system shuts down or enters a sleep mode.

Although several examples of the oxygen generating system 10 including the oxygen generating unit 100, 100′ have been described hereinabove, it is to be understood that such description is not intended to be limited thereto. For example, the oxygen generating unit 100, 100′ may otherwise be driven by piston rod(s), which may be driven mechanically rather than electromagnetically. For instance, the piston 106, 106′ may be driven by a crankshaft or another suitable actuator, forcing the piston 106, 106′ to oscillate between the first 12 and second 14 sieve beds. In an example, the crankshaft driving the piston 106, 106′ may be driven using an electric motor including, but not limited to, a brushless DC motor, a stepper motor, or the like. Such construction may be similar to that used for automotive engines. In this instance, the piston 106, 106′ would not include the magnets 108 driven by an electric coil 116.

It is to be understood that the term “connect/connected” is broadly defined herein to encompass a variety of divergent connection arrangements and assembly techniques. These arrangements and techniques include, but are not limited to (1) the direct connection between one component and another component with no intervening components therebetween; and (2) the connection of one component and another component with one or more components therebetween, provided that the one component being “connected to” the other component is somehow operatively connected to the other component (notwithstanding the presence of one or more additional components therebetween).

While several embodiments have been described in detail, it will be apparent to those skilled in the art that the disclosed embodiments may be modified and/or other embodiments may be possible. Therefore, the foregoing description is to be considered exemplary rather than limiting.

What is claimed is:

1. An oxygen generating system, comprising:
an oxygen generating unit including a housing having operatively disposed therein:
at least two sieve beds;
a piston disposed between, and operatively connected to the at least two sieve beds; and
at least one magnet selectively acting on the piston; and
a coil wrapped around an exterior surface of the housing and in operative communication with the at least one magnet, the coil being configured to drive the piston, via an electromagnetic field formed between the coil and the at least one magnet, along a length of the housing between the at least two sieve beds during at least one stage of an oxygen generating cycle for generating an oxygen-enriched gas for a user.

2. The oxygen generating system as defined in claim 1 wherein: each of the at least two sieve beds has associated therewith at least two valves, the at least two valves operatively connected to the oxygen generating unit; one of the at least two valves is configured for an inflow of the feed gas; and an other of the two valves is configured for an outflow of exhaust gas formed during the oxygen-generating cycle.

3. The oxygen generating system as defined in claim 1 wherein the piston is formed from a non-ferrous material.

4. The oxygen generating system as defined in claim 1 wherein the piston includes at least one ring disposed thereon, the at least one ring configured to provide an air-tight seal, substantially preventing fluid communication between the at least two sieve beds.

5. The oxygen generating system as defined in claim 1 wherein the piston has a circumference, and wherein the at least one magnet is operatively disposed 1) on the piston, and 2) around the circumference of the piston.

6. The oxygen generating system as defined in claim 1 wherein the piston is a moveable sleeve including a divider, and wherein the at least one magnet is contained inside the moveable sleeve adjacent the divider.

7. The oxygen generating system as defined in claim 6, further comprising at least one ring disposed in the sleeve, the at least one ring configured to substantially prevent fluid communication between the at least two sieve beds.

8. The oxygen generating system as defined in claim 6 wherein the sleeve includes at least one port formed therein and configured to allow fluid communication into and out of the oxygen generating unit.

9. The oxygen generating system as defined in claim 1, further comprising:
a product tank operatively connected to the oxygen generating unit and configured to store an output of the oxygen-enriched gas; and
at least one check valve operatively connected to the at least one sieve bed and the product tank, wherein the at least one check valve is configured open and close in response to changes in pressure of the at least one sieve bed and a flow of gas back into the at least one sieve bed.

10. The oxygen generating system as defined in claim 1 wherein the oxygen generating system is portable.

11. The oxygen generating system as defined in claim 1, further comprising a chassis, wherein the oxygen generating unit is shock mounted to the chassis.

12. The oxygen generating system as defined in claim 1, further comprising a processor configured to drive, during multiple stages of an oxygen generating cycle, the piston between first and second positions of the oxygen generating unit.

13. A method of generating an oxygen-enriched gas, the method comprising:
providing an oxygen generating system, including:
an oxygen generating unit including a housing having operatively disposed therein:
at least two sieve beds;
a piston disposed between, and operatively connected to the at least two sieve beds; and
at least one magnet selectively acting on the piston; and
a coil wrapped around an exterior surface of the housing and in operative communication with the at least one magnet, wherein the coil is configured to drive the piston along a length of the housing between the at least two sieve beds, via an electromagnetic field formed between the coil and the at least one magnet; and
generating the oxygen-enriched gas from a feed gas introduced to the oxygen generating system via an oxygen generating cycle, the oxygen generating cycle including multiple oxygen generating stages, each stage corresponding to a stroke of the piston.

14. The method as defined in claim 13 wherein: the oxygen generating system further includes i) a fill valve and a vent valve operatively connected to the oxygen generating unit, and ii) a check valve operatively connected to a product tank; and the multiple stages of the oxygen generating cycle include a fill stage, a compression stage, a depressurization stage, a vacuum stage, and a vent stage.

15. The method as defined in claim 14 wherein during the fill stage, the method further comprises:
opening the fill valve of the at least one sieve bed;
closing the vent valve of the at least one sieve bed; and
driving the piston to a first position in the oxygen generating unit, during which the at least one sieve bed is supplied with the feed gas; and
closing the fill valve when the piston reaches the first position.

16. The method as defined in claim 15 wherein: the at least one sieve bed includes a nitrogen-adsorption material disposed therein; and during the compression stage, the method further comprises:
driving the piston to a second position in the oxygen generating unit;
pressurizing the at least one sieve bed and adsorbing nitrogen from the feed gas in the nitrogen-adsorption material; and
opening the check valve, thereby allowing the oxygen-enriched gas to enter the product tank.

17. The method as defined in claim 16 wherein during the depressurization stage and the vacuum stage, the method further comprises:
opening the vent valve, thereby depressurizing the at least one sieve bed;
closing the vent valve after the depressurization; and
driving the piston to the first position of the oxygen generating unit, thereby drawing a vacuum into the at least one sieve bed and desorbing at least a portion of the nitrogen from the nitrogen-adsorption material.

18. The method as defined in claim 17 wherein the vent valve is opened either i) for a predetermined time period, or ii) until a desired pressure of the at least one sieve bed has been reached, the desired pressure being relative to an ambient pressure.

19. The method as defined in claim 17 wherein during the vent stage, the method further comprises:
opening the vent valve of the at least one sieve bed;
driving the piston to the second position of the oxygen generating unit, thereby driving the at least the portion of the desorbed nitrogen from the at least one sieve bed; and
closing the vent valve when the piston reaches the second position.

20. The method as defined in claim 19 wherein the driving of the piston is accomplished by energizing the coil in a pattern to produce a force sufficient to move the piston between the first and second positions of the oxygen generating unit.
